(19) United States
(12) Patent Application Publication
(10) Pub. No.: US 2004/0110100 A1
(43) Pub. Date: Jun. 10, 2004

(54) Photographic processing

(75) Inventor: John R. Fyson, Hackney (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/701,989

(22) Filed: Nov. 5, 2003

(30) Foreign Application Priority Data
Nov. 30, 2002 (GB) 0228159.0

(51) Int. Cl. G03C 7/42

(52) U.S. Cl. 430/393; 430/430

(57) ABSTRACT

The invention provides a method of photographic processing, comprising the step of applying a layer of a catalyst to the surface of a developed silver halide photographic material to promote aerial oxidation of silver within the photographic material. The catalyst promotes aerial oxidation of silver enabling a reduction in the amount of chemistry required.

This is a U.S. Original Patent Application which claims priority on United Kingdom Patent Application No. 0228159.0 filed Nov. 30, 2002.

### FIELD OF THE INVENTION

The present invention relates to a method of processing silver halide photographic materials and in particular to the processing of silver halide photographic material that includes a silver oxidation step. The oxidation step might involve a bleaching step where silver in the photographic material is oxidised to a halide ready for subsequent removal in a fixing stage, or in low silver coating weight materials, stabilisation or just a washing step.

### BACKGROUND OF THE INVENTION

Conventionally, photographic processing involves the execution of a number of chemical processing steps on exposed silver halide photographic material such as colour photographic paper or film. Processing solutions are used to execute the chemical processing steps.

An initial step in the processing is development of the material using a colour developer. During the development step, dye corresponding to a captured image is formed in the material and exposed silver halide is converted to silver. The silver is preferably removed typically by bleaching of the developed photographic material. The silver can be removed directly by a bleach-fixing step or it can be converted via bleaching to a form suitable for removal by a fixing agent. Silver oxidation occurs in one case during the bleaching where the silver in the material is oxidised to a halide ready for subsequent removal in a fix, or in the other case by bleach-fixing where the silver is oxidised and removed in one step. In both cases, conventionally the bleach or bleach-fixing step follows the development step and its purpose is to remove silver. Optionally, there may be some intervening steps such as a stop e.g. using dilute acetic acid.

Conventionally, the bleaching or bleach fixing is carried out in a tank. However, recently there have been moves to make processing machines without tanks and therefore smaller, the processing solutions being applied directly to the surface of the photographic material using an appropriate applicator or application method. Appropriate applicators or application methods include spraying, inkjetting, rollers or blades.

A metered single application of fresh processing solution is used such that each piece of photographic material sees the same chemical processing solutions (chemistry) and is not subject to any previous processing history, as was usually the case with tank processing. This removes the need for constant process control, as there should be no change in processing solution constitution. This also removes the need for maintaining constant composition by replenishment or other means. This implies that replenishment pumps are no longer needed. Additionally, there is no tank recirculation required and accordingly there is no need for any means of recirculation. This reduces the number of pumps, as these can be replaced with a metering pump to apply the solution in some manner to the photographic material surface.

Single use of a processing solution also allows the use of chemistry that is unstable to carry out the processing steps, as two or more stable parts of a processing solution can be brought together immediately before application to, or on the surface of the material being processed. The use of the unstable chemistry could have processing benefits, e.g. allows the use of a stable RX system where the amount of silver required to obtain a good silver image is much reduced.

The metered application to the surface also allows the possibility of applying the processing solution image-wise to reduce the amount of chemistry required. For example, U.S. patent application Ser. No. 10/164,066 in the name of Evans et al discloses a method of photographic processing using image-wise surface application of processing solution. Accordingly smaller amounts of chemistry can be applied in low-density image areas, than are applied in high-density image areas.

EP 0 984 324A1 in the name of Konica discloses the use of inkjet-like technology to apply processing solutions to colour paper.

Bleach-fixes containing metal complexes are well known in the art. These are usually used in deep tanks. It is known that the reduced complexes are oxidised slowly in these tanks by air. Such a process is described in, for example, European Patent Number EP 0 151 305B.

### PROBLEM TO BE SOLVED BY THE INVENTION

The problem with metered application of processing solutions is that sufficient chemistry has to be applied as a uniform layer of known thickness to all parts of the photographic material to carry out the respective processing step to completion in all areas. This results in a waste of chemistry in the areas where no such complete reaction has to occur. For example in a photographic print, the maximum density area contains silver halide developed to its maximum extent. It is therefore necessary to apply sufficient oxidant to this area to remove all the silver created in the maximum density area during development. Substantially less oxidant is required for minimum density areas since in these areas there will be less silver to be oxidised. Applying a uniform amount of chemistry to the material to ensure sufficient processing in both maximum density and minimum density areas is expensive in terms of chemical cost and possible impact on the environment.

Image-wise application of chemistry does provide for variation in the amount of chemistry applied to photographic material in dependence on image density, however, image information is needed prior to processing and complex control systems can be required.

### SUMMARY OF THE INVENTION

According to the present invention, there is provided a method of photographic processing comprising the step of applying a layer of an aerially regenerable catalyst to the surface of a developed silver halide photographic material to enable oxidation of silver within the photographic material.

Preferably, the thickness of the layer of catalyst satisfies the following condition:

$$thickness < \frac{1}{2} \sqrt{\frac{{DtnL}_{O}}{{L}_{Ag} - {L}_{O}}}$$

in which,

D is the average of the diffusion coefficient of the oxidised and reduced species of the catalyst, expressed in m²/s;

t is the process step time in seconds;

L_{O} is the laydown of the catalyst expressed in mol/m²;

L_{Ag} is the laydown of the developed silver in the material to be oxidised, expressed in mol/m²; and, n in the number of electrons transferred in the oxidising step.

### ADVANTAGEOUS EFFECT OF THE INVENTION

The invention provides a method of photographic processing that uses direct application for processing chemicals to the surface of photographic material being processed. Accordingly, there is no requirement for processing tanks and the corresponding large volumes of processing chemicals such systems typically require.

Furthermore, the invention requires the use of a layer of a catalyst applied to the surface of the developed silver halide photographic material to enable oxidation of silver in the material to silver halide. A catalyst is a material that is unchanged after the reactions in which it is involved have occurred. In this case although as an intermediate step the catalyst is reduced as a result of its oxidising effect on silver in the photographic material, the subsequent reaction with atmospheric air to re-oxidise the catalyst is extremely fast at the interface of the layer of catalyst with air e.g. the reaction takes from about 0.01 seconds to about 2 seconds. The catalyst is therefore quickly returned to its original form. The catalyst is therefore unchanged after the reactions in which it is involved.

Based on conventional knowledge it was unexpected that if a catalyst such as an aerially regenerable bleach or bleach-fix is applied in a layer to the surface of the developed material, the ensuing aerial oxidation of silver in the photographic material is sufficient to convert all silver in the material into silver halide for subsequent removal. The amount of catalyst required is substantially less than would be required if it were not aerially regenerable. The aerial regeneration of the catalyst enables a fixed amount of the catalyst to work more than once, since after functioning once it is regenerated so that it can work again. The method of the present invention is therefore efficient in terms of amount of chemistry used and effect on the environment. It is surprising that the reaction between the reduced catalyst and atmospheric air is fast enough to enable a lesser amount of catalyst e.g. a thin layer, to perform all the required oxidation of silver in the photographic material.

In other words, for a given amount of silver per square metre in the photographic material, the amount of catalyst or oxidising agent required is considerably less than would be required if the catalyst was not regenerable. This is equivalent to the most of the bleaching being carried out by air and the metal complex acting as an electron transfer agent. The method of the present invention can therefore be said to rely on aerial oxidation of the silver with the catalyst e.g. a metal complex, acting as an electron transfer agent.

Optionally, after application of the catalyst, a layer of an oxidising agent may be applied to the photographic material, as in conventional surface application processing.

Accordingly, the problem with metered application of processing solutions that sufficient chemistry has to be applied as a uniform layer of known thickness to all parts of the print to carry out the respective processing step to completion in all areas, is overcome. This results in a substantial reduction in waste of chemistry in the areas where no such complete reaction has to occur. Since less chemistry can therefore be used, without any reduction in the quality or degree of processing, the process provided by the present invention is less expensive than conventional processing methods in terms of both cost of chemicals and possible impact on the environment.

The catalyst laid down on the developed material might be a bleach or bleach-fix using a metal complex bleaching agent e.g. iron (III) EDTA, iron (III) PDTA, iron (III) EDDS, iron (III) MIDA or cobalt (III) hexammine. As the metal complex oxidises silver in the photographic material, it is reduced creating a reduced metal complex. The present invention utilizes the surprising fact that aerial oxidation of the reduced metal complex is fast enough to allow further silver oxidation in a relatively short processing time. Typically the processing time is of the order of tens of seconds e.g. up to 60 s, whereas the timescale for regeneration of the catalyst is of the order of tenths of seconds e.g. up to 2 seconds.

### DETAILED DESCRIPTION OF THE INVENTION

The invention relates to photographic processing in which processing solutions are applied directly to the surface of photographic material to be processed. The processing solution required for each of the required processing steps e.g. development, bleach, fix, wash is applied in a metered way to the surface of the photographic material using any suitable method of application. Examples include inkjet, spraying, application with a roller, a wiper or a blade.

A developer is applied to exposed photographic material. This serves to form dye in the photographic material corresponding to a cantured image and also to convert exposed silver halide to silver. After the developer has acted a layer of a catalyst is applied to the surface of the photographic material. The catalyst is selected to promote aerial oxidation of silver back to silver halide for removal from the photographic material.

Unexpectedly, the use of a catalyst or bleaching agent that is aerially regenerable enables the amount of catalyst or bleaching agent used to be considerably smaller than would conventionally have been thought necessary given the amount of silver in photographic material. In fact the subsequent bleach step used in conventional processing may even be unnecessary. To maximise the benefit from the present invention, a catalyst should be chosen for which the rate of aerial regeneration of the catalyst is substantially faster than the time required for the processing step. Typically, if the time required for the processing step is of the order of tens of seconds say between 45 and 60 seconds, the time required for aerial regeneration of the catalyst via exposure to the atmosphere should be of the order of tenths of seconds e.g. from about 0.01 second to about 2 seconds, preferably from about 0.05 second to 0.5 seconds. It is preferable that the time required for aerial regeneration of the catalyst via exposure to the atmosphere is substantially shorter than the time required for the processing step, e.g. such that the time required for the processing step is between about 22 and about 6000 times longer than that required for aerial regeneration of the catalyst.

It is preferable that the layer of catalyst is thin, having a thickness that satisfies the following condition:

$$thickness < \frac{1}{2} \sqrt{\frac{{DtnL}_{O}}{{L}_{Ag} - {L}_{O}}} metres$$

where D is the average of the diffusion coefficient of the oxidised and reduced species of a reversible catalyst e.g. bleaching agent, expressed in 2/S;

t is the process step time in seconds;

L_{O} is the laydown of the reversible bleaching agent expressed in mol/m²;

L_{Ag} is the laydown of the developed silver in the material to be bleached, expressed in mol/m²; and

n in the number of electrons transferred in the bleaching step (or the number of silver atoms oxidised per molecule of bleaching agent in each step).

More preferably, the thickness of the layer of catalyst is such that it satisfies the condition

$$thickness < \frac{1}{4} \sqrt{\frac{{DtnL}_{O}}{{L}_{Ag} - {L}_{O}}} metres .$$

This can be approximately related to the laydown in ml/m² by multiplying this number by 106 which is the same as the solution laydown thickness expressed in microns.

An example of a suitable catalyst is an aerially regenerable bleach or bleach-fix. Such a bleach or bleach-fix might use a metal complex bleaching agent e.g. iron (III) EDTA, iron (III) PDTA, iron (III) EDDS, iron (III) MIDA or cobalt (III) hexammine. Surprisingly, aerial oxidation of the reduced metal complex used as the bleaching agent is fast enough to allow further silver oxidation in the typically short processing time. In other words, most of the bleaching is carried out by air, with the metal complex acting as the catalyst or electron transfer agent.

### EXAMPLES

The invention will be exemplified with the help of the examples below:

### Example 1

The following solutions were prepared

| | |
|---|---|
| Developer | |
| water | 800 ml |
| 2-pyrolidinone | 200 g |
| N,N′diethyl hydroxylamine | 10 g |
| NaOH | 10 g |
| CD3 free base* | 30 g |
| Silwet L-7607 (TM Witco Chemical Co.) | 5 g |
| water to | 1 litre |
| pH adjusted to 13.2 | |
| Bleach-fix | |
| water | 500 mls |
| sodium metabisulfite | 15 g |
| ammonium thiosulfate | 60 g |
| acetic acid | 10 g |
| animonium iron (III) EDTA | 30 g |
| water to | 1 litre |
| pH adjusted to 5.5 at 25 C | |

*CD Free Base Preparation

0.5 g hydroxylamine sulphate and 0.5 g sodium sulphite (these were present as anti oxidants) were dissolved in 50 mls of water. Into this was dissolved 10 g CD3. To this mixture was added potassium hydrogen carbonate very slowly until the pH rose to about 8 (using papers to test). The CD3 free base had mostly precipitated. This mixture was then shaken in a separating funnel with 200 mls ethyl acetate to extract the free base. The solid was extracted into the ethyl acetate. The mixture was separated and the ethyl acetate phase allowed to evaporate in an evaporating dish in the fume cupboard overnight at room temperature. No further purification was attempted as it was thought this might encourage oxidation. The free base was obtained as small very pale brown-grey crystals.

These solutions were put in previously emptied “Hewlett Packard” black ink-jet cartridges designed for use with a “DeskJet 420” printer. This was facilitated by the drilling of a small hole in the top of the cartridge.

Two “Hewlett Packard” “DeskJet 420” printers were connected to a suitable PC; loaded with the appropriate drivers, through a switch to enable them to be controlled independently. Parts of these printers were removed to allow pieces of 10 cm wide photographic paper to be transported under the ink-jet cartridge without the surface being touched by either the cartridge or a roller. The refilled ink-jet cartridges were then loaded according to the maker's instructions, into these printers. Suitable files written in “Adobe PhotoShop” that could sent to each of the printer to cause them to “print” solution at a rate of 20 ml/m² over an exposed area on the photographic paper.

Strips of 10 cm wide Kodak Ektacolor Edge 8 paper were given a wedge exposure in the normal way.

The strips were processed in the dark at room temperature (23C) as follows: the print file was downloaded to both printers. No printing took place until paper was sensed by them. The exposed paper was put in the printer containing the developer, whereupon ‘printing’ started and developer was laid down at 20 mls/m². When the “printing” of the print had finished the paper was held in the hand until 1 minute had elapsed since the start of the developer application. The print was put in the printer containing the bleach-fix. After application of the bleach-fix the paper was left on a bench for 1 minute before it was washed in a tank of flowing water for a further 2 minutes. This was allowed to dry.

The silver remaining in the strip was determined by X-ray fluorescence spectroscopy. The amount of silver remaining was determined in each wedge step and found to be <2 mg/m² (the limit of determination).

### Example 2

Example 1 was repeated except that the bleach-fix in the ink-jet cartridge was replaced with a 5% acetic acid solution as a stop bath. This would not be expected to remove any silver. The amount of silver determined in the maximum density areas of the print was 510 mg/m².

The silver developed in the maximum developed area was 510 mg/m² which is equivalent to 4.7×10⁻³ mol/m². The iron (III) laydown was equivalent to 30/363×0.02=1.65×10⁻³ mol/m². We can see that more silver was oxidised than to stoichiometry with iron (III) predicted suggesting that the iron (II) formed in the bleaching reaction was being regenerated by air in the short time of the experiment.

What is claimed is:

1. A method of photographic processing, comprising the step of
applying a layer of an aerially regenerable catalyst to the surface of a developed silver halide photographic material to enable oxidation of silver within the photographic material.

2. A method according to claim 1, further comprising after the step of applying a thin layer of a catalyst, the step of
applying an oxidising agent to the surface of the developed silver halide photographic material to convert any remaining silver in said material to silver halide.

3. A method according to claim 1, in which the catalyst is selected such that the time required for aerial regeneration of the catalyst at the interface of said layer of catalyst with air is from about 0.01 seconds to about 2 seconds.

4. A method according to claim 1, in which the catalyst is a bleaching agent.

5. A method according to claim 1, in which the layer of catalyst applied to the photographic material is uniform.

6. A method according to claim 5, in which the layer of catalyst has a thickness that satisfies the following condition:
$$thickness < \frac{1}{2} \sqrt{\frac{{DtnL}_{O}}{{L}_{Ag} - {L}_{O}}}$$
in which,
D is the average of the diffusion coefficient of the oxidised and reduced species of the catalyst, expressed in m²/s;
t is the process step time in seconds;
L_{O} is the laydown of the catalyst expressed in mol/m²;
L_{Ag} is the laydown of the developed silver in the material to be oxidised, expressed in mol/m²; and
n in the number of electrons transferred in the oxidising step.

7. A method according to claim 6, in which the layer of catalyst has a thickness that satisfies the following condition:
$$thickness < \frac{1}{4} \sqrt{\frac{{DtnL}_{O}}{{L}_{Ag} - {L}_{O}}} .$$

8. A method according to claim 4, in which the bleaching agent comprises a metal complex bleaching agent.

9. A method according to claim 8, in which the metal complex bleaching agent is selected from the group consisting of iron (III) PDTA, iron (III) EDDS, iron (III) MIDA and cobalt (III) hexammine.
